(19) United States
(12) Patent Application Publication
(10) Pub. No.: US 2026/0212304 A1
(43) Pub. Date: Jul. 23, 2026

(54) SYSTEMS AND METHODS FOR VERIFIED DRIVER RISK CREDENTIALING

(71) Applicant: Quanata, LLC, San Francisco, CA (US)

(72) Inventors: Eric Christopher Dahl, Newman Lake, WA (US); James Patrick Ryan, Roswell, GA (US); Brandon Gredler, San Francisco, CA (US)

(73) Assignee: Quanata, LLC, San Francisco, CA (US)

(21) Appl. No.: 19/028,079

(22) Filed: Jan. 17, 2025

(51) Int. Cl. G06Q 10/0639; G06Q 50/43; G07C 5/04

(52) U.S. Cl. CPC G06Q 10/06393; G06Q 50/43; G07C 5/04

(57) ABSTRACT

A computer-implemented method for generating driver risk credentials. The method can include obtaining telematics data from an electronic device of a driver over a time period. The method also can include generating, using a trained model, a driver risk score for the driver based on the telematics data. The method additionally can include transmitting a verified digital credential for the driver to a recipient, wherein the verified digital credential is based on the driver risk score. Other embodiments are described.

### FIELD OF DISCLOSURE

The present disclosure relates generally to systems and methods for verified driver risk credentialing.

### BACKGROUND

Safety and risk assessment have become increasingly relevant in various industries involving transportation and service provision. There is a growing need for reliable methods to evaluate and credential individuals performing certain tasks. Traditional assessment methods may not capture real-time behavior or provide a comprehensive view of current risk profiles. Technological advancements have opened new possibilities for monitoring and analyzing behavior, though challenges remain in effectively using this data.

### BRIEF DESCRIPTIONS OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

These are shown are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an exemplary embodiment of the system disclosed in FIG. 3:

FIG. 2 illustrates a representative block diagram of an example of the elements included in the circuit boards inside a chassis of the computer system of FIG. 1;

FIG. 3 illustrates a block diagram of a computer system for providing verified driver risk credentialing, according to an embodiment; and

FIG. 4 illustrates a flowchart of a method for providing verified driver risk credentialing, according to an embodiment.

The figures depict preferred embodiments for purposes of illustration only. One skilled in the art will readily recognize from the following discussion that alternative embodiments of the systems and methods illustrated herein can be employed without departing from the principles of the technology herein.

### DETAILED DESCRIPTION OF EXAMPLES OF EMBODIMENTS

The present embodiments can generally relate to providing verified driver risk credentialing. Driver safety and risk assessment have become increasingly important in various industries, particularly those involving transportation and delivery services. With the rise of ride-sharing platforms, gig economy jobs, and contract-based delivery services, there is a growing need for reliable methods to evaluate and credential drivers. Traditionally, driver risk assessment has relied on historical data such as driving records, traffic violations, and accident reports. However, these methods often fail to capture real-time driving behavior and may not provide a comprehensive view of a driver's current risk profile. Additionally, the process of verifying driver credentials and assessing risk can be time-consuming and inconsistent across different platforms or employers.

The advent of telematics technology has opened new possibilities for monitoring and analyzing driving behavior. Telematics devices and smartphone applications can collect data on various aspects of driving, including speed, acceleration, braking, and cornering. However, the effective use of this data to generate meaningful risk assessments and credentials remains a challenge. Furthermore, as the workforce becomes increasingly mobile and flexible, with drivers often working for multiple platforms or switching between different types of driving jobs, there is a need for portable and universally recognized driver credentials. Current systems often require drivers to undergo separate vetting and credentialing processes for each platform or employer, leading to inefficiencies and redundancies.

The integration of artificial intelligence and machine learning technologies in risk assessment models presents opportunities for more accurate and dynamic driver evaluations. However, developing robust models that can account for the diverse range of driving conditions, vehicle types, and job-specific requirements poses significant technical challenges. Privacy and data security concerns also present hurdles in the implementation of comprehensive driver risk assessment systems. Balancing the benefits of detailed driving data with drivers' rights to privacy and control over their personal information is an ongoing challenge in the industry. As the transportation and delivery sectors continue to evolve, there is a clear benefit to having innovative solutions that can provide accurate, real-time driver risk assessments and universally recognized credentials while addressing the complexities of the modern driving landscape.

In many embodiments, the systems and methods described herein can provide a credentialing approach, which in some embodiments, can offer a standardized, portable credential that can be recognized across multiple platforms or employers, which can reduce redundant vetting processes and improve efficiency in the gig economy and contract-based services.

In various embodiments, various embodiments include a computer-implemented method for obtaining telematics data from an electronic device of a driver over a time period. The method also can include generating, using a trained model, a driver risk score for the driver based on the telematics data. The method additionally can include transmitting a verified digital credential for the driver to a recipient, wherein the verified digital credential is based on the driver risk score.

Additional embodiments include a system comprising one or more processors and one or more non-transitory computer-readable media storing computing instructions that, when executed on the one or more processors, cause the one or more processors to perform certain operations. The operations can include obtaining telematics data from an electronic device of a driver over a time period. The operations also can include generating, using a trained model, a driver risk score for the driver based on the telematics data. The operations additionally can include transmitting a verified digital credential for the driver to a recipient, wherein the verified digital credential is based on the driver risk score.

Further embodiments include one or more non-transitory computer-readable media storing computing instructions that, when executed by one or more processors, cause the one or more processors to perform certain operations. The operations can include obtaining telematics data from an electronic device of a driver over a time period. The operations also can include generating, using a trained model, a driver risk score for the driver based on the telematics data. The operations additionally can include transmitting a verified digital credential for the driver to a recipient, wherein the verified digital credential is based on the driver risk score.

Still further embodiments include a system comprising first means for obtaining telematics data from an electronic device of a driver over a time period. The system also can include second means for generating, using a trained model, a driver risk score for the driver based on the telematics data. The system additionally can include third means for transmitting a verified digital credential for the driver to a recipient, wherein the verified digital credential is based on the driver risk score.

Advantages will become more apparent to those skilled in the art from the following description of the preferred embodiments which have been shown and described by way of illustration. As will be realized, the present embodiments can be capable of other and different embodiments and their details are capable of modification in various respects. Accordingly, the drawings and descriptions are to be regarded as illustrative in nature and not as restrictive.

In several embodiments, the techniques described herein can provide a practical application and several technological improvements. The techniques describe herein can provide several technical improvements. For example, in many embodiments, the systems and methods described herein can provide real-time risk assessment by facilitating continuous monitoring and evaluation of driver behavior, which can offer more accurate and up-to-date risk profiles compared to traditional methods relying solely on historical data. In many embodiments, the systems and methods described herein can provide enhanced data utilization, such as by leveraging telematics data and advanced analytics to provide more comprehensive insights into driving behavior, which can lead to more meaningful and nuanced risk assessments. In many embodiments, the systems and methods described herein can provide adaptability to diverse conditions through artificial intelligence and machine learning models to account for various driving conditions, vehicle types, and job-specific requirements, which can offer more accurate and context-aware risk evaluations. In many embodiments, the systems and methods described herein can provide privacy-conscious design, which can incorporate features to balance the obtaining detailed driving data with privacy concerns, which can address a challenge in implementing comprehensive driver risk assessment systems. These benefits can provide significant advantages over conventional approaches.

### Exemplary Computer Settings

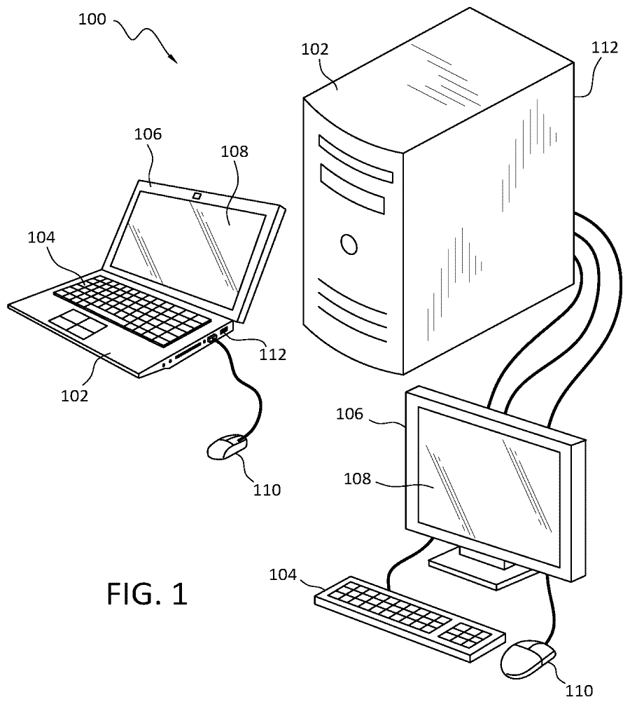

Turning to the drawings, FIG. 1 illustrates an exemplary embodiment of two different types (e.g., a laptop and a tower server) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia interface (HDMI) ports, etc.).

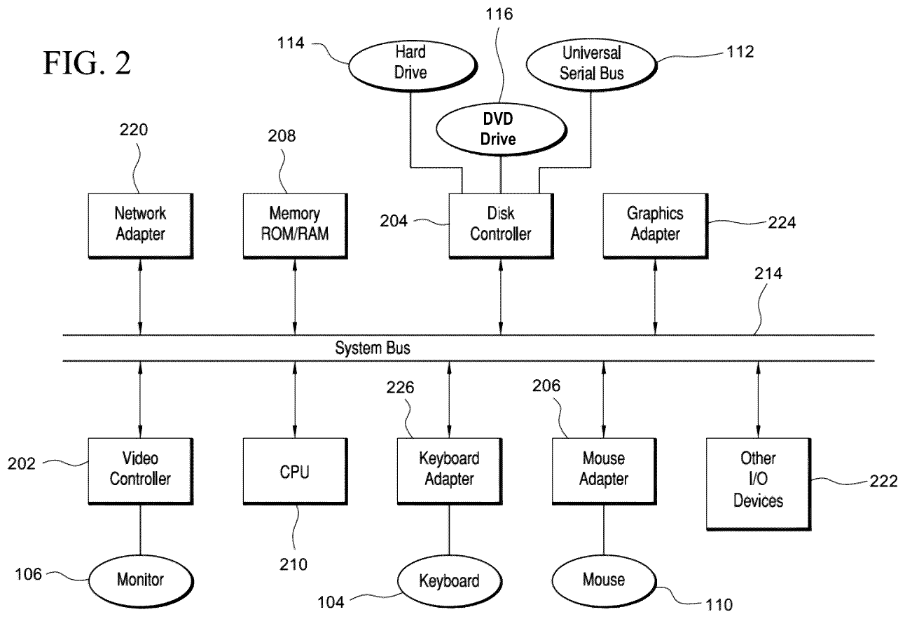

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to a memory storage unit 208 that includes both read only memory (ROM) and random-access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage unit(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS.

Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Mayada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general-purpose computer to a special purpose computer.

For purposes of illustration, programs and other executable program components are shown herein as discrete systems, although it is understood that such programs and components can reside at various times in different storage components of computer system 100 and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, smart rings, wearable, virtual reality headset, augmented reality glasses, etc. In certain additional embodiments, computer system 100 can comprise an embedded system.

### Exemplary Computer Systems for Verified Driver Risk Credentialing

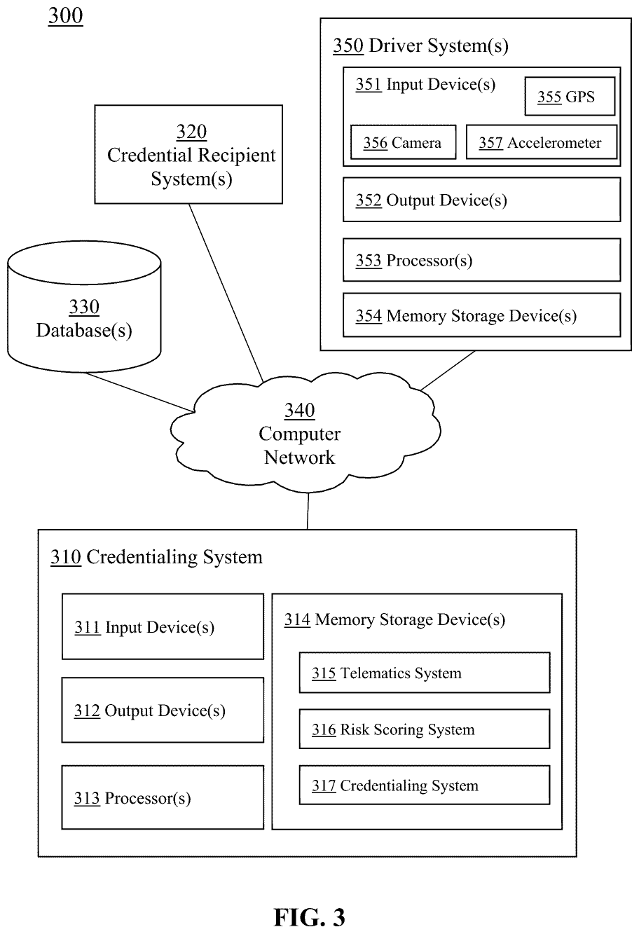

Turning ahead in the drawings, FIG. 3 illustrates a block diagram of a system 300 for providing verified driver risk credentialing, according to an embodiment. System 300 is exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a credentialing system 310, one or more credential recipient systems 320 (e.g., one for each recipient), one or more driver systems 350 (e.g., one for each driver), an/or other suitable systems. Credentialing system 310, credential recipient system 320, and driver system 350 can each be a computer system, such as computer system 100 (FIG. 1), as described above, and can each be a single computer, a single server, or a cluster or collection of computers or servers, or a cloud of computers or servers. In another embodiment, a single computer system can host each of credentialing system 310, credential recipient system 320, and driver system 350.

In various embodiments, credentialing system 310 can includes modules of computing instructions (e.g., software modules) stored on non-transitory computer readable media that operate on one or more processors. In other embodiments, credentialing system 310 can be implemented in hardware. In many embodiments, credentialing system 310 can comprise one or more systems, subsystems, modules, models, or servers, such as a telematics system 315, a risk scoring system 316, and/or a credentialing system 317. These systems can be implemented, at least in part, in software and/or firmware stored in or loaded on memory storage device(s) 314 and executed on processor(s) 313. Additional details regarding credentialing system 310, credential recipient system 320, and/or driver system 350 are described herein.

In some embodiments, credentialing system 310 can be in data communication, through a computer network, a telephone network, or the Internet (e.g., computer network 340), with credential recipient system 320, and/or driver system 350. In some embodiments, driver system 350 can be used by a driver to track telematics data for the driver, which can be used by credentialing system 310 to in generating a digital credential for the driver.

In several embodiments, credential recipient system 320 can be used by recipient(s) of the credential generated by credentialing system 310. For example, credentialing system 310 can transmit the credential to credential recipient system 320. In some embodiments, the recipient can be the driver, a ride-share employer (or potential employer) of the driver, a car rental company that evaluates the driver, a fleet operator that evaluates the driver, or another suitable recipient of the credential.

In some embodiments, driver system 350 can include one or more input devices (e.g., input device(s) 351), one or more output devices (e.g., output device(s) 352), one or more processors (e.g., processor(s) 353), and/or one or more memory storage devices (e.g., memory storage device(s) 354). Examples of input device(s) 351 can include one or more keyboards, one or more keypads, one or more pointing devices such as a computer mouse or computer mice, one or more touchscreen displays, a microphone, keyboard 104 (FIG. 1), mouse 110 (FIG. 1), a Global Positioning System (GPS) 355, a camera 356, an accelerometer 357, etc. Examples of output device(s) 352 can include one or more monitors, one or more touch screen displays, projectors, monitor 106 (FIG. 1), screen 108 (FIG. 1), etc. Examples of processor(s) 353 can include CPU 210 (FIG. 2), etc. Examples of memory storage device(s) 354 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc.

Input device(s) 351 and output device(s) 352 can be coupled to driver system 350 in a wired manner and/or a wireless manner, and the coupling can be direct and/or indirect, as well as locally and/or remotely. In a similar manner, processor(s) 353 and/or memory storage device(s) 354 can be local and/or remote to each other.

In various embodiments, driver system 350 can be a mobile device, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, smart rings, an augmented-reality (AR) headset, a virtual-reality (VR) headset, etc.), or another portable computer device with the capability to present audio and/or visual data (e.g., images, videos, music, etc.).

Thus, in several examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, or (ii) the Android™ operating system developed by the Open Handset Alliance.

In various embodiments, credentialing system 310 can include: (a) one or more input devices (e.g., input device(s) 311 such as one or more keyboards, one or more keypads, one or more pointing devices such as a computer mouse or computer mice, one or more touchscreen displays, a microphone, a camera, etc.), (b) one or more display or output devices (e.g., output device(s) 312 such as one or more monitors, one or more touch screen displays, projectors, etc.), (c) one or more processors (e.g., processor(s) 313), and/or (d) one or more memory storage devices (e.g., memory storage device(s) 354 such as one or more internal or external memory storage units, one or more hard drives, one or more CD-ROM or DVD drives, etc.). In these or other embodiments, one or more of the input device(s) (e.g., input device(s) 311) can be similar or identical to keyboard 104 (FIG. 1) and/or a mouse 110 (FIG. 1). Further, one or more of the display device(s) (e.g., output device(s) 312) can be similar or identical to monitor 106 (FIG. 1) and/or screen 108 (FIG. 1). Additionally, one or more of the processors (e.g., processor(s) 313) can be similar or identical to CPU 210 (FIG. 2). In similar or different embodiments, one or more of the memory storage devices (e.g., memory storage device(s) 314) can be similar or identical to memory storage unit 208 (FIG. 2), external storage units coupled to input/output port 112 (FIGS. 1-2), hard drive 114 (FIG. 2), CD-ROM and/or DVD drive 116 (FIG. 2), or a detachable drive coupled to input/output port 112 (FIGS. 1-2).

The input device(s) (e.g., input device(s) 311) and the display device(s) (e.g., output device(s) 312) can be coupled to credentialing system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple the input device(s) (e.g., input device(s) 311) and the display device(s) (e.g., output device(s) 312) to the processor(s) (e.g., processor(s) 313) and/or the memory storage unit(s) (e.g., memory storage device(s) 314). In some embodiments, the KVM switch also can be part of credentialing system 310. In a similar manner, the processors and/or the non-transitory computer-readable media can be local and/or remote to each other.

Meanwhile, in several embodiments, credentialing system 310 also can be configured to communicate with one or more databases (e.g., a database(s) 330). The one or more databases can include a database the contains telematics data, risk scores, digital credentials, for example, among other information. The one or more databases additionally can include one or more of trained machine learning (ML) and/or artificial intelligence (AI) models (the ML/AI models) used in system 300 and/or credentialing system 310. The one or more databases further can include training datasets for various ML/AI models, modules, or systems, including risk scoring models used by risk scoring system 316, etc. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, credentialing system 310, and/or the one or more databases (e.g., database(s) 330) can be implemented using any suitable manner of wired and/or wireless communication. Accordingly, system 300 and/or credentialing system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In some embodiments, the systems of system 300 can work together to process driver data, generate risk scores, and provide verified digital credentials. In some cases, the credentialing system 310 can process telematics data, generating driver risk scores, and issuing verified digital credentials. Credential recipient system 320 can receive and utilize the verified digital credentials. Databases 330 can store relevant data for the credentialing process. Computer network 340 can facilitate communication between the various components of the system 300. Driver system 350 can collect and transmit telematics data about the driver's behavior and vehicle operation.

For example, driver system 350 can use various sensors (e.g., input devices 351) for collecting telematics data about the driver's behavior and vehicle operation. GPS 355 can provide location and speed data; camera 356 cab capture visual information about the driver's environment and behavior; and accelerometer 357 can detect acceleration, braking, and cornering forces, for example. In some examples, these sensors can be integrated into the vehicle and/or part of the driver system 350. The telematics data can include information such as speed, acceleration, braking patterns, cornering behavior, time of day, weather conditions, and other relevant driving metrics. Driver system 350 can transmit the collected telematics data to other components of the system 300, such as the credentialing system 310, via the computer network 340. This transmission may occur in real-time or at periodic intervals, depending on the specific implementation. In many cases, the driver can be a human. In other cases, the driver associated with the driver system 350 can be an AI driving model. In such cases, driver system 350 can be integrated into an autonomous vehicle or a simulation environment, collecting and transmitting telematics data generated by the AI driving model's operation of the vehicle.

In many embodiments, credentialing system 310 can obtain the telematics data from driver system 350 of a driver over a time period. In some embodiments, the time period can be hours, days, weeks, months, years, or another suitable time period. In some embodiments, telematics system 315 can process and analyze the obtained telematics data. As examples, telematics system can perform data cleaning and preprocessing, such as filtering out erroneous or irrelevant data points, handling missing values, normalizing data across different devices or vehicle types. For example, telematics system can perform outlier detection, interpolation for missing values, and/or data standardization. In some embodiments, telematics system 315 can perform trip segmentation, which can divide continuous streams of data into discrete trips. This process can involve identifying start and end points based on ignition events, prolonged stops, or significant changes in GPS coordinates. In some embodiments, telematics system 315 can perform feature extraction, which can derive higher-level features from raw sensor data. For example, telematics system can calculate metrics such as average speed, number of hard braking events per mile, or time spent in different speed ranges. In some embodiments, telematics system 315 can perform contextual enrichment, which can augment raw sensor data with contextual information, such as matching GPS coordinates to road types, speed limits, and points of interest, or incorporating weather data for the time and location of each trip. In some embodiments, telematics system 315 can perform behavior pattern identification, which can employ algorithms to detect specific driving behaviors, such as using accelerometer data to identify aggressive acceleration, hard braking, or sharp cornering events. In some embodiments, telematics system 315 can perform anomaly detection, which can implement algorithms to identify unusual patterns or events in the data, such as detecting potential accidents, unauthorized vehicle use, or sudden changes in driving behavior. In some embodiments, telematics system 315 can perform data aggregation, which can compute summary statistics over various time periods to provide an overview of driving patterns and trends. In some embodiments, telematics system 315 can perform comparative analysis, which can compare a driver's data against benchmarks or peer groups to provide relative performance metrics. In some embodiments, telematics system 315 can perform time series analysis, which can apply time series analysis techniques to identify trends, seasonality, or cyclical patterns in driving behavior over time. In some embodiments, telematics system 315 can perform geospatial analysis, which can perform spatial analysis on GPS data to understand driving patterns in different geographic areas or types of roads. In some embodiments, telematics system 315 can use machine-learning model to classify driving events based on patterns in the telematics data. In some embodiments, telematics system 315 can perform data visualization, which can generate visual representations of the processed data, such as heat maps of frequent routes, graphs of speed profiles, or dashboards summarizing key metrics. In some embodiments, telematics system 315 can employ edge computing techniques, performing initial processing and analysis on the driver's device before transmitting summarized data to the central system, which can help reduce data transmission costs and latency while preserving privacy. In some embodiments, telematics system 315 can implement adaptive processing techniques, adjusting its analysis based on the specific characteristics of each driver or vehicle. For example, it may calibrate accelerometer thresholds for detecting harsh events based on the suspension characteristics of different vehicle types.

In many embodiments, risk scoring system 316 can generate a driver risk score based on the telematics data. In some cases, the driver risk score can be a holistic contextual risk score that can factor in more than just driving behavior. In some embodiments, risk scoring system 316 can utilize one or more machine-learning models to generate comprehensive driver risk scores. The risk scoring process can incorporate multiple factors and data sources to provide a holistic assessment of driver risk.

For example, risk scoring system 316 can employ a gradient boosting model, such as XGBoost or LightGBM, to process telematics data and generate an initial risk score. This model can be trained on historical data that includes telematics information and/or known outcomes (e.g., accidents, traffic violations). The model can consider features such as acceleration patterns (frequency of hard accelerations), braking behavior (frequency of hard braking events), cornering (G-forces during turns), speed adherence (percentage of time spent over the speed limit), time of day driving patterns, weather conditions during trips, road types frequently traveled, and/or other suitable factors.

In some embodiments, risk scoring system 316 can incorporate a deep neural network to analyze image data from camera 356. This model can be trained to detect distracted driving behaviors, such as phone usage or eating while driving. The output from this model can be combined with the telematics-based score to provide a more comprehensive risk assessment.

In some embodiments, risk scoring system 316 can use a recurrent neural network (RNN) or long short-term memory (LSTM) network to analyze patterns in driving behavior over time. Such models can allow the system to identify trends or changes in a driver's risk profile, potentially flagging sudden increases in risky behavior.

In some embodiments, risk scoring system 316 can employ a random forest model to incorporate additional contextual data, such as driver demographics, driving history (past accidents or violations), vehicle type and safety features, geographic location (urban vs. rural driving), trip purpose (personal vs. work-related), etc. This model can help adjust the risk score based on factors not captured in the real-time telematics data.

In some embodiments, risk scoring system 316 can use an ensemble method, combining the outputs of multiple models to produce a final risk score. This approach can involve techniques such as weighted averaging or stacking, where a meta-model is trained to optimally combine the predictions of the base models.

In some embodiments, risk scoring system 316 can continuously update and refine its models based on new data and outcomes. For instance, risk scoring system 316 can use online learning techniques to adjust model parameters in real-time as new telematics data is received. In some cases, risk scoring system 316 can generate sub-scores for different aspects of driving risk (e.g., distraction risk, speeding risk, time-of-day risk) in addition to an overall risk score. These sub-scores can provide more granular insights into a driver's behavior and may be used to tailor specific interventions or training programs.

In some embodiments, risk scoring system 316 can incorporate external data sources to enhance its risk assessment. For example, it may use APIs to access real-time traffic and weather data, allowing it to contextualize driving behavior based on current conditions. In some embodiments, risk scoring system 316 can employ federated learning techniques to improve its models while preserving driver privacy, which can allow the system to learn from data across multiple drivers and organizations without directly accessing sensitive information.

In some embodiments, the output of the risk scoring system 316 can be a numerical score (e.g., 1-100), a categorical rating (e.g., low, medium, high risk), or another suitable type of score. In some cases, the system may also provide confidence intervals or uncertainty estimates along with its risk predictions.

In many embodiments, credentialing system 317 can create and transmit a verified digital credential for the driver to a recipient. The verified digital credential can be based on the driver risk score. In some cases, the verified digital credential may comprise at least one of a tier or a score. In some embodiments, credentialing system 310 can verify the identity of the driver. The identity verification can be based on at least one of behavior, voice recognition, retinal scan, or fingerprint recognition. In some embodiments, the verified digital credential can be based on this identity verification. In some embodiments, the verified digital credential can include a verification logo. In some embodiments, the verified digital credential can be a digital certificate.

In some embodiments, credentialing system 310 can use self-sovereign identity architecture, in which the driver can control their data and credentials. This architecture can allow drivers to choose who can access their verified digital credential, such as to which recipients the credential can be sent. For example, the architecture can issue a digital identity wallet to drivers that stores their verified credentials and allows them to selectively share specific information with authorized parties. Credentialing system 317 can issue verified digital credentials as tamper-proof, cryptographically signed attestations about the driver's risk score or other attributes. When a credential recipient, such as a ride-share platform, asks to verify a driver's credentials, the recipient can request specific information directly from the driver's digital wallet. The driver can then choose to grant or deny access to the requested information, maintaining control over their personal data. This architecture can enable drivers to carry portable, verifiable credentials across multiple platforms or employers while preserving their privacy and data ownership. In some embodiments, when the driver agrees to share data with a third party, remuneration can be provided by the third party to the driver and/or the entity providing the credentialing service.

In some embodiments, the verified digital credential can be valid for a predetermined time period. In some cases, the verified digital credential may be renewable for a second predetermined time period. In some embodiments, credentialing system 310 can automatically delete the verified driving credential from a secure digital platform on a device of the recipient. This deletion can be based on one or more of: a lapse of the verified driving credential, a security breach of the device, and/or a notification that the device is lost. In many embodiments, credentialing system 310 can be operated by an entity that is different from (and not affiliated through control or ownership) one or more of the recipients operating credential recipient systems 320 and/or the drivers operating driver systems 350, such that the credentials provided by credentialing system 310 can provide trusted third-party verification.

In many embodiments, credential recipient systems 320 can be configured to receive and utilize verified digital credentials generated by the credentialing system 310. In some embodiments, credential recipient systems 320 can be operated recipients, which can be entities that have an interest obtaining information about a driver's risk and/or safety abilities, in evaluating driver such risk, and/or in providing such information to others, such as the recipient's customers.

In some embodiments, credential recipient system 320 can be operated by a fleet operator. The fleet operator can use the verified digital credentials received by the credential recipient system 320 to evaluate drivers for their fleet, such as for hiring, for performance evaluation, etc.

In some cases, credential recipient system 320 can be operated by the driver. The driver can access their own verified digital credentials through the credential recipient system 320, allowing them to view and manage their driving risk profile, and/or to display or otherwise send the credential to others.

In some embodiments, credential recipient system 320 can be operated by a car rental company. The car rental company may use the credential recipient system 320 to receive and evaluate verified digital credentials when assessing potential car renters.

In some embodiments, credential recipient system 320 can be operated by a ride-share employer. The ride-share employer may use the credential recipient system 320 to receive and evaluate verified digital credentials of drivers applying to or currently working for their platform.

In some embodiments, credential recipient system 320 can be configured to securely store and manage the received verified digital credentials. In some embodiments, credential recipient system 320 can include functionality to display, analyze, or compare the received credentials. In some embodiments, the credential recipient system 320 can also be configured to integrate the received credentials into existing evaluation or decision-making processes of the operating entity. For example, a recipient that is a ride-share company can display a credential for a driver to customers of the ride-share company. As another example, a car rental company can provide a discount to a customer based on the credential.

### Exemplary Methods for Verified Driver Risk Credentialing

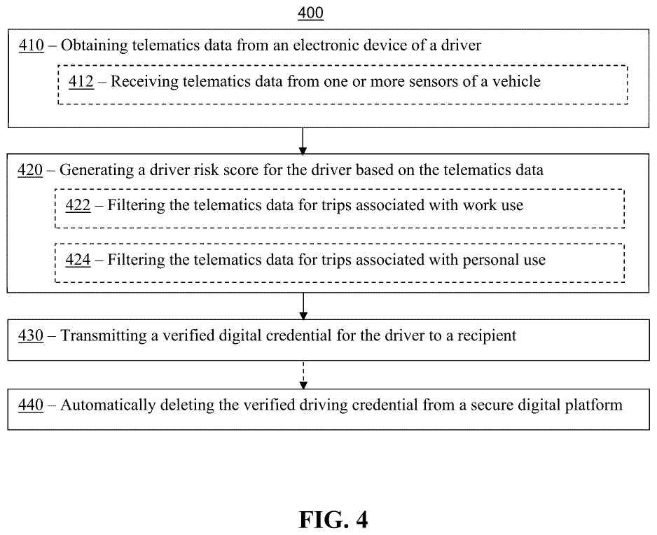

Turning ahead in the drawings, FIG. 4 illustrates a flowchart of a method 400 for providing verified driver risk credentialing, according to an embodiment. Method 400 can be implemented via execution of computing instructions configured to run on one or more processors and stored on one or more non-transitory computer-readable media. Method 400 is exemplary and is not limited to the embodiments presented herein. Method 400 can be employed in many different embodiments or examples not specifically depicted or described herein. In various embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined or skipped.

In several embodiments, system 300 or credentialing system 310 (FIG. 3) (including one or more of its elements, modules, and/or systems, such as telematics system 315, risk scoring system 316, and/or credentialing system 317 (FIG. 3)) can be suitable to perform method 400 and/or one or more of its operations, actions, and/or activities. In these or other embodiments, one or more of the operations, actions, and/or activities of method 400 can be implemented as computing instructions configured to run on one or more processors and be stored on one or more non-transitory computer readable media. Such media can be part of system 300 or credentialing system 310 (FIG. 3). The processor(s) can be similar or identical to those described for computer system 100 (FIG. 1).

Referring to FIG. 4, in several embodiments, method 400 can include an activity 410 of obtaining telematics data from an electronic device of a driver over a time period. In many embodiments, the driver can be a human. In other embodiments, the driver can be an AI driving model. The electronic device can be similar or identical to driver system 350 (FIG. 3). In many embodiments, telematics system 315 (FIG. 3) can obtain the telematics data from driver system 350 (FIG. 3). In some embodiments, activity 410 can include an activity 412 of receiving telematics data from one or more sensors of a vehicle. In some embodiments, credentialing system can provide and/or interface with an application that runs on driver system 350 (FIG. 3) to obtain such telematics data. The telematics data obtained from driver system can be obtained by driver system 350 (FIG. 3) from sensors, such as GPS 355, camera 356, and/or accelerometer 357 (FIG. 3).

In many embodiments, method 400 also can include an activity 420 of generating, using a trained model, a driver risk score based on the telematics data. Activity 420 can include using telematics system 315 and/or risk scoring system 316 (FIG. 3) to process the telematics data and produce a risk assessment. In some embodiments, activity 420 can include an activity 422 of filtering telematics data from trips associated with work use and/or activity 424 of filtering the telematics data for trips associated with personal use. In some cases, drivers operate their vehicles differently depending on the use of the vehicle, and filtering based on use can provide information that can be relevant for a particular type of safe driving credential. In some embodiments, the verified digital credential comprises at least one of a tier or a score. In some embodiments, the verified digital credential can include a verification logo, which can indicate that the credential is certified by the entity operating credentialing system 310. In some embodiments, the verified digital credential can include a digital certificate, which can be used by the recipient to verify that the credential was signed and sent by credentialing system 310, which can prevent or mitigate imposters who may try to send credentials using the certification.

In many embodiments, method 400 additionally can include an activity 430 of transmitting a verified digital credential for the driver to a recipient. The recipient can be a ride-share employer of the driver, a car rental company that evaluates the driver, a fleet operator that evaluates the driver, the driver, and/or another suitable recipient. In some embodiments, the verified digital credential can be based on the driver risk score. In some embodiments, activity 430 can involve using credentialing system 317 (FIG. 3) to create and securely transmit the credential to an authorized recipient. In some embodiments, the verified digital credential can be based on verification of an identity of the driver. In some embodiments, the identity of the driver can be verified based on at least one of behavior, voice recognition, retinal scan, and/or fingerprint recognition. In some embodiments, the verified driving credential can be valid for a predetermined time period, and/or can be renewable for a second predetermined time period.

In some embodiments, method 400 optionally and additionally can include an activity 440 of automatically deleting the verified driving credential from a secure digital platform on a device of the recipient based on a lapse of the verified driving credential, a security breach of the device, a notification that the device is lost, and/or another suitable deletion condition. In some embodiments, credentialing system 310 (FIG. 3) can provide and/or interface with a secure digital platform (e.g., a secure application) that runs on credential recipient system 320 (FIG. 3) to provide the credentials, to provide updates to the credential, and/or to delete the credentials.

### Exemplary Machine Learning Models

In several embodiments, the systems and/or methods can use one or more ML/AI models to perform one or more of the above-mentioned procedures, processes, activities, actions, operations, and/or methods. Further, the systems and/or methods can use, and the one or more ML/AI models can include, one or more facial-expression-recognition models, one or more eye-tracking models, and/or one or more NLP models for processing the one or more inputs and/or outputs from the one or more activation controls and/or the one or more user interactions. Examples of the algorithms used for the various ML/AI models can include BERT, LLM, Lambda, Palm, XLNet, GPT-3, GPT-4, KNN, decision trees, linear regression, logistic regression, K-Means, neural networks, fuzzy logic, GANs, CTGAN, CNNs, VAEs, and so forth. In various embodiments, each of the ML/AI models used can be trained dynamically and/or regularly.

In various embodiments, the systems and/or methods can be configured to train or re-train the one or more ML/AI models. The training of each of the ML/AI models can be supervised, semi-supervised, and/or unsupervised—which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., database(s) 330 (FIG. 3)). In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In many embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In various embodiments, where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

### Additional Considerations

Although providing verified driver risk credentialing has been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIGS. 1-4 can be modified, and that the foregoing discussion of certain of these embodiments does not necessarily represent a complete description of all possible embodiments. Additionally, one or more of the procedures, processes, operations, actions, and/or activities of the method in FIG. 4 can include different procedures, processes, actions, and/or activities and be performed by many different modules, in many different orders. As another example, the elements and/or systems within system 300 or credentialing system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, ten seconds, or thirty seconds, for example.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method comprising:
obtaining telematics data from an electronic device of a driver over a time period;
generating, using a trained model, a driver risk score for the driver based on the telematics data; and
transmitting a verified digital credential for the driver to a recipient, wherein the verified digital credential is based on the driver risk score.

2. The computer-implemented method of claim 1, wherein obtaining the telematics data comprises:
receiving telematics data from one or more sensors of a vehicle of the driver over the time period.

3. The computer-implemented method of claim 1, wherein generating the driver risk score comprises:
filtering the telematics data for trips associated with work use.

4. The computer-implemented method of claim 1, wherein generating the driver risk score comprises:
filtering the telematics data for trips associated with rental use.

5. The computer-implemented method of claim 1, wherein the trained model is a machine-learning risk model.

6. The computer-implemented method of claim 1, wherein the verified digital credential is based on verification of an identity of the driver.

7. The computer-implemented method of claim 6, wherein the identity of the driver is verified based on at least one of behavior, voice recognition, retinal scan, or fingerprint recognition.

8. The computer-implemented method of claim 1, wherein:
the verified driving credential is valid for a predetermined time period; and
the verified digital credential is renewable for a second predetermined time period.

9. The computer-implemented method of claim 1, wherein the verified digital credential comprises at least one of a tier or a score.

10. The computer-implemented method of claim 1, wherein the verified digital credential comprises a verification logo.

11. The computer-implemented method of claim 1, wherein the verified digital credential comprises a digital certificate.

12. The computer-implemented method of claim 1, wherein the recipient is a ride-share employer of the driver.

13. The computer-implemented method of claim 1, wherein the recipient is a car rental company that evaluates the driver.

14. The computer-implemented method of claim 1, wherein the recipient is a fleet operator that evaluates the driver.

15. The computer-implemented method of claim 1, wherein the recipient is the driver.

16. The computer-implemented method of claim 1 further comprising:
automatically deleting the verified driving credential from a secure digital platform on a device of the recipient based on one or more of: a lapse of the verified driving credential, a security breach of the device, or a notification that the device is lost.

17. The computer-implemented method of claim 1, wherein the driver is an AI driving model.

18. A system comprising one or more processors and one or more non-transitory computer-readable media storing computing instructions that, when executed on the one or more processors, cause the one or more processors to perform operations comprising:
obtaining telematics data from an electronic device of a driver over a time period;
generating, using a trained model, a driver risk score for the driver based on the telematics data; and
transmitting a verified digital credential for the driver to a recipient, wherein the verified digital credential is based on the driver risk score.

19. One or more non-transitory computer-readable media storing computing instructions that, when executed by one or more processors, cause the one or more processors to perform operations comprising:
obtaining telematics data from an electronic device of a driver over a time period;
generating, using a trained model, a driver risk score for the driver based on the telematics data; and
transmitting a verified digital credential for the driver to a recipient, wherein the verified digital credential is based on the driver risk score.

20. A system comprising:
first means for obtaining telematics data from an electronic device of a driver over a time period;
second means for generating, using a trained model, a driver risk score for the driver based on the telematics data; and
third means for transmitting a verified digital credential for the driver to a recipient, wherein the verified digital credential is based on the driver risk score.
